(19) United States
(12) Patent Application Publication
(10) Pub. No.: US 2013/0155503 A1
(43) Pub. Date: Jun. 20, 2013

(54) AUTO-STEREOSCOPIC THREE DIMENSIONAL DISPLAY

(71) Applicants: Wei-Ting Yen, Taipei City (TW); Chi-Lin Wu, New Taipei City (TW); Fu-Hao Chen, Kaohsiung City (TW); Chao-Hsu Tsai, Hsinchu City (TW)

(72) Inventors: Wei-Ting Yen, Taipei City (TW); Chi-Lin Wu, New Taipei City (TW); Fu-Hao Chen, Kaohsiung City (TW); Chao-Hsu Tsai, Hsinchu City (TW)

(73) Assignee: INDUSTRIAL TECHNOLOGY RESEARCH INSTITUTE, Hsinchu (TW)

(21) Appl. No.: 13/445,915

(22) Filed: Apr. 13, 2012

(30) Foreign Application Priority Data
Dec. 19, 2011 (TW) 100147012

(51) Int. Cl. G02B 27/22

(52) U.S. Cl. 359/463

(57) ABSTRACT

An auto-stereoscopic type 3D-display including a transmissive display panel, a dynamic backlight module and a light guiding unit is provided. The dynamic backlight module is disposed at a side of the transmissive display panel and includes a plurality of bar-shaped light sources parallel to each other and a miniature lens. Each of the bar-shaped light sources includes an illumination region and the width of the illumination region is W1. The miniature lens is disposed between the transmissive display panel and the bar-shaped light sources. An image formed from each of the bar-shaped light sources is outside the miniature lens and has the width of W2, wherein W1/W2=n, and n is an integer greater than 1. In addition, the light guiding unit is disposed between the transmissive display panel and the miniature lens such that the image formed from each of the bar-shaped light sources is directed to different viewing domains.

### CROSS-REFERENCE TO RELATED APPLICATION

This application claims the priority benefit of Taiwan application serial no. 100147012, filed on Dec. 19, 2011. The entirety of the above-mentioned patent application is hereby incorporated by reference herein and made a part of this specification.

### BACKGROUND

1. Technical Field

The present disclosure relates to an auto-stereoscopic 3D-display, and more particularly to a multi-view auto-stereoscopic 3D-display.

2. Description of Related Art

As technology advances and develops, people's eagerness for better material life and spiritual life are increasing without a pause. When it comes to the spiritual life, in the world of technology, most people have the desire to realize their imagination and to experience it vividly with the help of various display devices. For this reason, how to develop display devices suitable for displaying three-dimensional images has become the goal to the manufacturers in the field.

The technology of three-dimensional display may be roughly categorized into two types. One is stereoscopic type which requires a viewer to wear specially designed glasses and the other is auto-stereoscopic type which allows the viewer to see directly with naked eyes. The stereoscopic type 3D-display is popular and is widely used in military or entertainment. However, it is inconvenient and uncomfortable to viewer to wear the specially designed glasses. Accordingly, the auto-stereoscopic type 3D-display has become the mainstream.

Recently, the auto-stereoscopic type 3D-display that provides multi-view function is developed. The characteristic of the multi-view auto-stereoscopic type 3D-display is that a plurality of viewers can see 3D images at various viewing domains at the same time. However, the more the viewing domains provided by the multi-view auto-stereoscopic type 3D-display, the lower the resolution of the 3D images viewed by each viewer is. For example, when n viewing domains are provided by the multi-view auto-stereoscopic type 3D-display, the resolution of the 3D images viewed by each viewer is 1/n times of the real resolution of the multi-view auto-stereoscopic type 3D-display.

In order to increase the resolution of 3D-image viewed by each viewer, display panels with higher resolution are proposed. However, display panels with higher resolution are difficult to fabricate and the fabrication cost thereof is difficult to be reduced. In addition, it is impossible to increase the real resolution of the multi-view auto-stereoscopic type 3D-display unlimitedly. Recently, since liquid crystal materials with high respond speed are developed, the data refresh frequency of liquid crystal display panels can be increased from 60-75 Hz to 120 Hz or 240 Hz. When a liquid crystal display panel with high data refresh frequency (e.g. 120 Hz or 240 Hz) and a directional backlight module are used, the liquid crystal display panel can provide two viewing domains (if the data refresh frequency of liquid crystal display panel is 120 Hz) or four viewing domains (if the data refresh frequency of liquid crystal display panel is 240 Hz) in each and every 1/60 second.

FIG. 1 schematically illustrates a conventional auto-stereoscopic type 3D-display. Referring to FIG. 1, the conventional auto-stereoscopic type 3D-display 100 includes a transmissive liquid crystal display panel 110, a plurality of bar-shaped light sources 120 parallel to each other and a plurality of lenticular lenses 130 parallel to each other. The lenticular lenses 130 are disposed between the transmissive liquid crystal display panel 110 and the bar-shaped light sources 120. Take the auto-stereoscopic type 3D-display 100 capable of providing four viewing domains as an example, the bar-shaped light sources 120 are divided into a plurality of bar-shaped light source groups G, and each of the bar-shaped light source groups G includes four bar-shaped light sources 120 neighboring to each other. The four bar-shaped light sources 120 of each bar-shaped light source group G are turned on sequentially, and light emitted from the four bar-shaped light sources 120 are respectively directed to four different viewing domains by the lenticular lenses 130.

In the conventional auto-stereoscopic type 3D-display 100, the width of each lenticular lens 130 is relevant to the width of each bar-shaped light source 120. When the auto-stereoscopic type 3D-display 100 provides four viewing domains, the width of each lenticular lens 130 is required to be less than 1000 micrometers and the width of each bar-shaped light source 120 is required to be less than 250 micrometers, such that the viewers may visually ignore the black stripes result from the lenticular lens 130 having excessive width. However, the width of the currently used bar-shaped light source 120 (e.g. LED bar-shaped light source) is usually greater than 250 micrometers. Accordingly, the width of each lenticular lens 130 is greater than 1000 micrometers and the black stripes are difficult to be avoided. When the auto-stereoscopic type 3D-display 100 provides more than four viewing domains, more than four bar-shaped light sources 120 are required to be installed beneath each lenticular lens 130. Accordingly, the width of each lenticular lens 130 is required to be greater and the black stripes become more obvious to viewers.

In the prior arts, it is difficult to further reduce the width of the bar-shaped light sources 120. How to enhance the display quality of the auto-stereoscopic type 3D-display 100 is an important issue to one ordinary skilled in the art.

### SUMMARY

The present disclosure provides an auto-stereoscopic type 3D-display having favorable display quality.

The present disclosure provides an auto-stereoscopic type 3D-display including a transmissive display panel, a dynamic backlight module and a light guiding unit. The dynamic backlight module is disposed at a side of the transmissive display panel and includes a plurality of bar-shaped light sources parallel to each other and a miniature lens. Each of the bar-shaped light sources includes an illumination region and the width of the illumination region is W1. The miniature lens is disposed between the transmissive display panel and the bar-shaped light sources. An image formed from each of the bar-shaped light sources is outside the miniature lens and has the width of W2, wherein W1/W2=n, and n is an integer greater than 1. In addition, the light guiding unit is disposed between the transmissive display panel and the miniature lens such that the image formed from each of the bar-shaped light sources is directed to different viewing domains.

In order to make the aforementioned and other features of the present disclosure more comprehensible, several embodiments accompanied with figures are described in detail below.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1 schematically illustrates a conventional auto-stereoscopic type 3D-display.

FIG. 2 schematically illustrates an auto-stereoscopic type 3D-display according to the first embodiment of the present disclosure.

FIG. 3 schematically illustrates an auto-stereoscopic type 3D-display according to the second embodiment of the present disclosure.

FIG. 4 schematically illustrates an auto-stereoscopic type 3D-display according to the third embodiment of the present disclosure.

FIG. 5 schematically illustrates an auto-stereoscopic type 3D-display according to the fourth embodiment of the present disclosure.

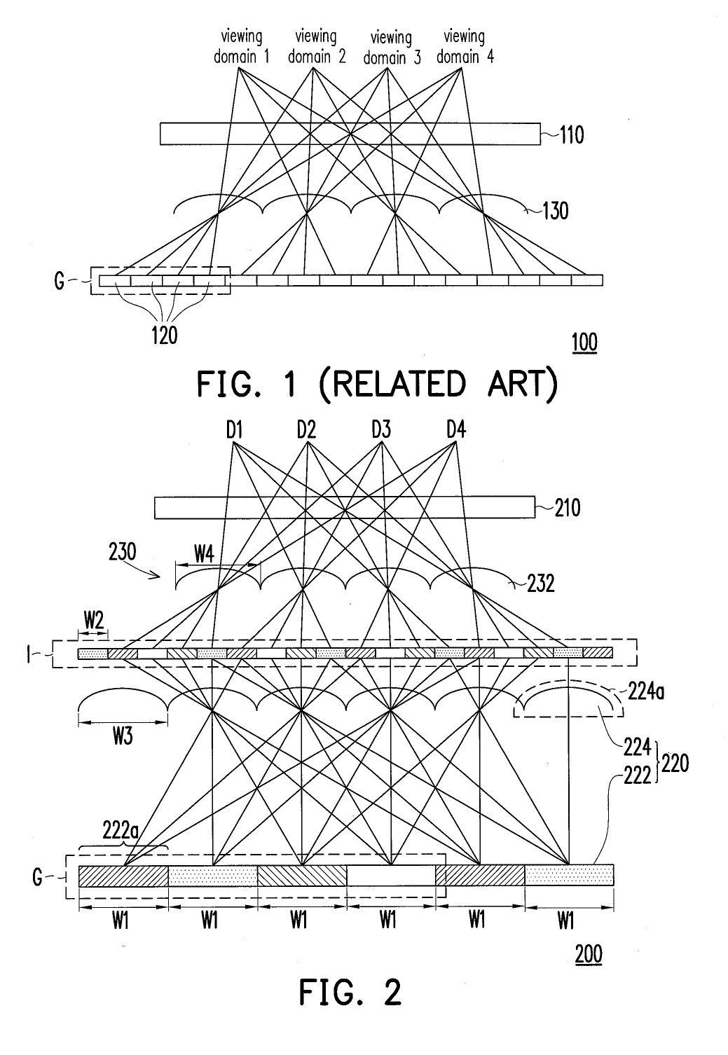

### DESCRIPTION OF EMBODIMENTS

### First Embodiment

FIG. 2 schematically illustrates an auto-stereoscopic type 3D-display according to the first embodiment of the present disclosure. Referring to FIG. 2, the auto-stereoscopic type 3D-display 200 of this embodiment includes a transmissive display panel 210, a dynamic backlight module 220 and a light guiding unit 230. The dynamic backlight module 220 is disposed at a side of the transmissive display panel 210 and includes a plurality of bar-shaped light sources 222 parallel to each other and a miniature lens 224. In this embodiment, the miniature lens 224 includes, for example, a plurality of first lenticular lenses 224a parallel to each other. Each of the bar-shaped light sources 222 includes an illumination region 222a and the width of the illumination region 222a is W1. The first lenticular lenses 224a is disposed between the transmissive display panel 210 and the bar-shaped light sources 222, wherein the bar-shaped light sources 222 are parallel with the first lenticular lenses 224a. In this embodiment, an image I formed from each of the bar-shaped light sources 222 is outside the first lenticular lenses 224a and has the width of W2, wherein W1/W2=n, and n is an integer greater than 1. In addition, the light guiding unit 230 is disposed between the transmissive display panel 210 and the first lenticular lenses 224a such that the image I formed from each of the bar-shaped light sources 222 is directed to different viewing domains D1-D4, respectively. It should be noted that the number of the viewing domains is not limited in the disclosure.

Since it is difficult to further reduce the width W1 of the bar-shaped light sources 222, the first lenticular lenses 224a are used and the image I outside the first lenticular lenses 224a is formed in this embodiment. Specifically, the image I is constituted by a plurality of repeatedly arranged miniatures of the bar-shaped light sources 222. The width of each miniature is 1/n times of the width of the image I. In addition, the overall illuminating area of the image I is substantially equal to the overall illuminating area of the bar-shaped light sources 222. When the quantity of the bar-shaped light sources 222 is A, the image I is constituted by (A*n) repeatedly arranged virtual bar-shaped light sources, and the width of each miniature is W1/n (i.e. W2). When the bar-shaped light sources 222 is sequentially turned on, the (A*n) repeatedly arranged virtual bar-shaped light sources in the image I are divided into groups and are turned on sequentially. In this embodiment, W1/W2=n=3.

As mentioned above, since the virtual bar-shaped light sources with smaller width (W2) can be obtained through the first lenticular lenses 224a without modifying the width W1 of the bar-shaped light sources 222, the black strips mentioned in prior arts can be effectively improved.

In this embodiment, the transmissive display panel 210 is a transmissive type liquid crystal display (LCD) panel. Certainly, one ordinary skilled in the art may use other suitable transmissive type display panels.

When four viewing domains D1-D4 are provided by the auto-stereoscopic type 3D-display 200, the data refresh frequency of the transmissive display panel 210 is, for example, equal to or greater than 240 Hz. In other words, the data refresh frequency of the image viewed by each viewer at the viewing domains D1-D4 is, for example, equal to or greater than 60 Hz. Accordingly, the image viewed by each viewer does not flicker easily. In order to co-operate with the transmissive display panel 210, the operation frequency of the bar-shaped light sources 222 and the data refresh frequency of the transmissive display panel 210 are synchronized. Specifically, when the quantity of the viewing domains is V, the bar-shaped light sources 222 are divided into a plurality of bar-shaped light source groups G, each of the bar-shaped light source groups G comprises V bar-shaped light sources 222 neighboring to each other, and the V bar-shaped light sources 222 of each of the bar-shaped light source groups G are turned on sequentially. It is noted that the operation frequency of the V bar-shaped light sources 222 of each bar-shaped light source group and the data refresh frequency of the transmissive display panel 210 are synchronized. For example, when the operation frequency of each bar-shaped light source 222 of each bar-shaped light source group G is 60 Hz, the data refresh frequency of the transmissive display panel 210 are synchronized to be (60*V) Hz.

In this embodiment, the width of each of the first lenticular lenses 224a is W3 and satisfies the equation: W3/W1=m, where m is a natural number. Since W3 is equal to W1, the ratio of W3 and W1 (m=W3/W1) is equal to 1. In other words, one bar-shaped light source 222 is installed beneath each first lenticular lens 224a. In this embodiment, the width (W1) of the bar-shaped light sources 222 ranges from 7 micrometers to 8 micrometers, and preferably, is about 7.5 micrometers. In this embodiment, the width (W3) of the first lenticular lenses 224a ranges from 2.33 micrometers to 2.67 micrometers, and preferably, is about 2.5 micrometers.

It is noted that the plurality of first lenticular lenses 224a can be integrated into a single optical element, and such optical element is so-call lenticular lens plate. The distance between the first lenticular lenses 224a and the bar-shaped light source 222 may be determined or properly modified based on design requirements. The distance between the first lenticular lenses 224a and the bar-shaped light source 222 is not limited in this disclosure. Similarly, the curvature of the first lenticular lenses 224a may be determined or properly modified based on design requirements (e.g. quantity of viewing domains, quantity of the bar-shaped light source 222, and so on). The curvature of the first lenticular lenses 224a is not limited in this disclosure.

As shown in FIG. 2, the light guiding unit 230, for example, includes a plurality second lenticular lenses 232 parallel to the first lenticular lenses 224a. In addition, the second lenticular lenses 232 of the light guiding unit 230 can be integrated into a single optical element, and such optical element is so-call lenticular lens plate.

In this embodiment, the width (W4) of the second lenticular lenses 232 ranges from 7 micrometers to 8 micrometers, and preferably, is about 7.5 micrometers. It is noted that the width (W4) of the second lenticular lenses 232 is not illustrated according to the actual scale.

It is note that the quantity (V) of the viewing domains is relevant to W1, W2 and W3. The quantity (V) of the viewing domains satisfies the equation: V=m*(n+1)/N, where m=W3/W1, n=W1/W2, and V, N are natural numbers. In other words, the maximum value of the quantity (V) of the viewing domains is [m*(n+1)] when N equals to 1. In this embodiment, since m equals to 1 (i.e. each first lenticular lens 224a is corresponding to one illumination region 222a) and n equal to 3 (i.e. the width of each virtual bar-shaped light sources is ⅓ times of the width of the illumination region 222a), the maximum value of the quantity (V) of the viewing domains is 4. It is noted that the auto-stereoscopic type 3D-display 200 of this embodiment can also provide two viewing domains (described in the second embodiment).

### Second Embodiment

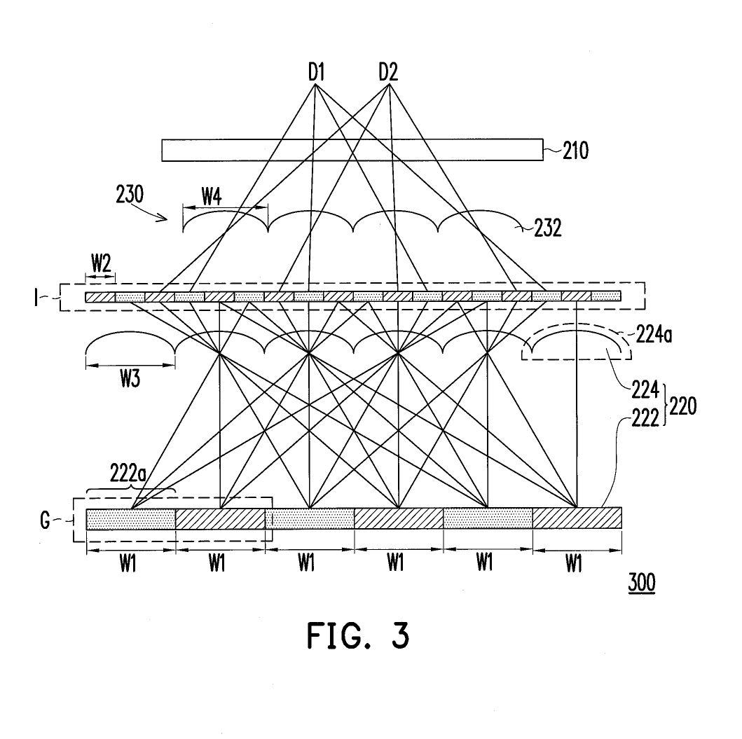

FIG. 3 schematically illustrates an auto-stereoscopic type 3D-display according to the second embodiment of the present disclosure. Referring to FIG. 3, the auto-stereoscopic type 3D-display 300 of this embodiment is similar with the auto-stereoscopic type 3D-display 200 of the first embodiment except that the auto-stereoscopic type 3D-display 300 merely provides two viewing domains D1-D2. In this embodiment, n equal to 3 (i.e. the width of each virtual bar-shaped light sources is ⅓ times of the width of the illumination region 222a), m equals to 1 (i.e. each first lenticular lens 224a is corresponding to one illumination region 222a), and N equals to 2. In comparison with the auto-stereoscopic type 3D-display 200 of the first embodiment, the data refresh frequencies of the transmissive display panel 210 and the dynamic backlight module 220 is reduced into a half. Accordingly, the quantity of the viewing domains is determined by the data refresh frequencies of the transmissive display panel 210 and the dynamic backlight module 220. In other words, the quantity of the viewing domains can be modified without changing the hardware of the auto-stereoscopic type 3D-display 300.

### The Third Embodiment

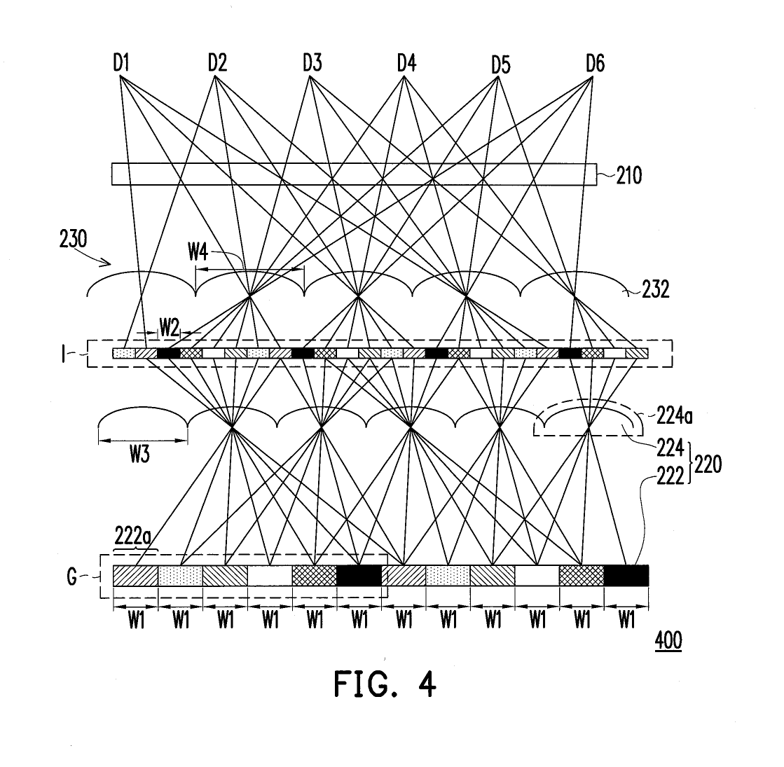

FIG. 4 schematically illustrates an auto-stereoscopic type 3D-display according to the third embodiment of the present disclosure. Referring to FIG. 4, the auto-stereoscopic type 3D-display 400 of this embodiment is similar with the auto-stereoscopic type 3D-display 200 of the first embodiment except that the auto-stereoscopic type 3D-display 400 provides six viewing domains D1, D2, D3, D4, D5 and D6. In this embodiment, n equal to 2 (i.e. the width of each virtual bar-shaped light source is ½ times of the width of the illumination region 222a), m equals to 2 (i.e. each first lenticular lens 224a is corresponding to two illumination regions 222a), and N equals to 1.

### The Fourth Embodiment

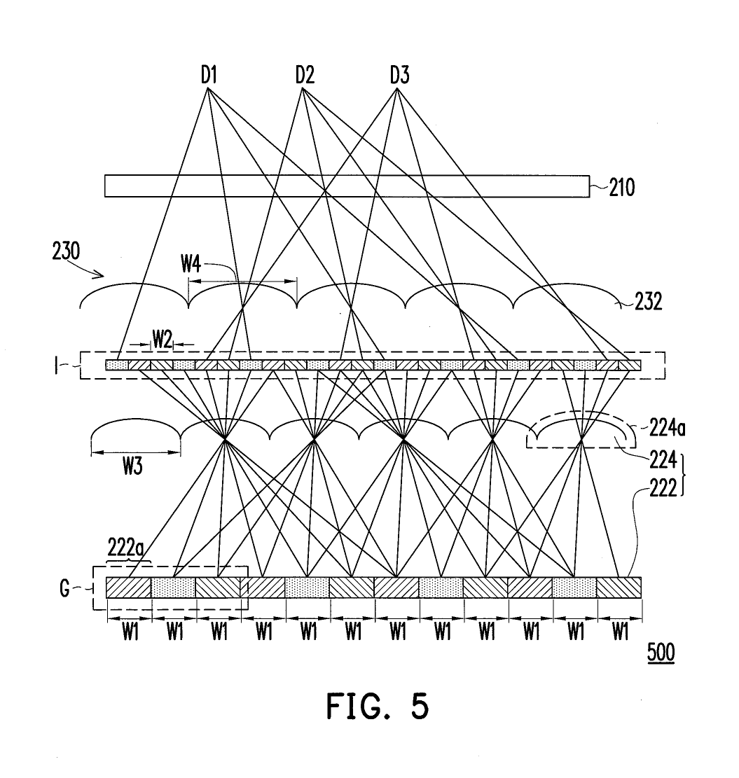

FIG. 5 schematically illustrates an auto-stereoscopic type 3D-display according to the fourth embodiment of the present disclosure. Referring to FIG. 5, the auto-stereoscopic type 3D-display 500 of this embodiment is similar with the auto-stereoscopic type 3D-display 400 of the third embodiment except that the auto-stereoscopic type 3D-display 500 provides three viewing domains D1, D2 and D3. In this embodiment, n equal to 2 (i.e. the width of each virtual bar-shaped light sources is ½ times of the width of the illumination region 222a), m equals to 2 (i.e. each first lenticular lens 224a is corresponding to two illumination regions 222a), and N equals to 2. In comparison with the auto-stereoscopic type 3D-display 500 of the third embodiment, the data refresh frequencies of the transmissive display panel 210 and the dynamic backlight module 220 is reduced into a half.

Since the miniature lens is used in this disclosure to overcome the technological bottleneck faced by prior arts, the auto-stereoscopic type 3D-display can be widely used in multi-view 3D-display field.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An auto-stereoscopic type 3D-display, comprising:
a transmissive display panel;
a dynamic backlight module disposed at a side of the transmissive display panel, the dynamic backlight module comprises:
a plurality of bar-shaped light sources parallel to each other, each of the bar-shaped light sources comprising an illumination region and the width of the illumination region is W1;
a miniature lens disposed between the transmissive display panel and the bar-shaped light sources, an image formed from each of the bar-shaped light sources being outside the miniature lens and having the width of W2, wherein W1/W2=n, and n is an integer greater than 1; and
a light guiding unit disposed between the transmissive display panel and the miniature lens, wherein the image formed from each of the bar-shaped light sources is directed to different viewing domains.

2. The auto-stereoscopic type 3D-display of claim 1, wherein the transmissive display panel includes a transmissive type liquid crystal display panel.

3. The auto-stereoscopic type 3D-display of claim 1, wherein the miniature lens comprises a plurality of first lenticular lenses parallel to each other, and the bar-shaped light sources are parallel with the first lenticular lenses.

4. The auto-stereoscopic type 3D-display of claim 3, wherein the width of each of the first lenticular lenses is W3 and satisfies the equation: W3/W1=m, where m is a natural number.

5. The auto-stereoscopic type 3D-display of claim 4, wherein each of the first lenticular lenses is corresponding to m bar-shaped light sources.

6. The auto-stereoscopic type 3D-display of claim 4, wherein a quantity of the viewing domains is V and satisfies the equation: V=m*(n+1)/N, and V, N are natural numbers.

7. The auto-stereoscopic type 3D-display of claim 1, wherein a quantity of the viewing domains is V, the bar-shaped light sources are divided into a plurality of bar-shaped light source groups, each of the bar-shaped light source groups comprises V bar-shaped light sources neighboring to each other, and the V bar-shaped light sources of each of the bar-shaped light source groups are turned on sequentially.

8. The auto-stereoscopic type 3D-display of claim 3, wherein the light guiding unit comprises a plurality of second lenticular lenses parallel to the first lenticular lenses.
